(19) United States
(12) Patent Application Publication
(10) Pub. No.: US 2026/0029050 A1
(43) Pub. Date: Jan. 29, 2026

(54) OFF-ROAD VEHICLE

(71) Applicant: KAWASAKI MOTORS, LTD., Akashi-shi (JP)

(72) Inventors: Hiromu TAKAHATA, Akashi-shi (JP); Takashi SHIOMITSU, Akashi-shi (JP); Yusuke FUJITA, Akashi-shi (JP)

(73) Assignee: KAWASAKI MOTORS, LTD., Akashi-shi (JP)

(21) Appl. No.: 19/274,684

(22) Filed: Jul. 21, 2025

(30) Foreign Application Priority Data
Jul. 29, 2024 (JP) 2024-122448

(51) Int. Cl. F16H 57/04; B60K 13/02; F16H 57/027

(52) U.S. Cl. CPC F16H 57/0489; B60K 13/02; F16H 57/027; F16H 57/0416; B60Y 2200/20

(57) ABSTRACT

A utility vehicle includes an engine intake duct connected to an engine to send external air to the engine, a CVT intake duct connected to a continuously variable transmission to send external air to the continuously variable transmission, and a fan intake duct connected to a fan to send external air to the fan. At least one of an intake port of the engine intake duct, an intake port of the CVT intake duct, or an intake port of the fan intake duct is located at a position higher than the upper end of a seat.

### CROSS-REFERENCE TO RELATED APPLICATION

This application claims priority to Japanese Patent Application No. 2024-122448 filed on Jul. 29, 2024. The entire contents disclosed in this Japanese patent application, which includes the specification, the drawings, and the claims, are incorporated by reference herein.

### FIELD

The technique disclosed here relates to an off-road vehicle.

### BACKGROUND

Typically, there has been known an off-road vehicle having an air intake assembly. For example, in an off-road vehicle disclosed in U.S. Pat. No. 11,293,540, an air intake assembly has an intake port, and supplies external air taken through the intake port to an engine.

### SUMMARY

In the off-road vehicle described above, there is a probability that when the off-road vehicle travels on a marshy area, a boggy area, or the like, a foreign substance kicked up by a wheel and scattered is sucked through the intake port.

The technique disclosed here has been made in view of such a point, and an object thereof is to reduce a probability of a foreign substance being sucked through an intake port.

The off-road vehicle disclosed here is an off-road vehicle including a seat, an engine, a continuously variable transmission, and a fan, which further includes an engine intake duct connected to the engine to send external air to the engine, a CVT intake duct connected to the continuously variable transmission to send external air to the continuously variable transmission, and a fan intake duct connected to the fan to send external air to the fan. At least one of an intake port of the engine intake duct, an intake port of the CVT intake duct, or an intake port of the fan intake duct is located at a position higher than the upper end of the seat.

The off-road vehicle disclosed here is an off-road vehicle including a seat and an engine, which further includes an engine intake duct connected to the engine to send external air to the engine. An intake port of the engine intake duct is located at a position higher than the upper end of the seat.

According to the off-road vehicle, a probability of the foreign substance being sucked through the intake port can be reduced.

### BRIEF DESCRIPTION OF THE DRAWINGS

FIG. 1 is a left side view of a utility vehicle.

FIG. 2 is a perspective view showing a duct assembly from the rear.

FIG. 3 is a schematic back view showing the duct assembly from the rear.

FIG. 4 is a perspective view showing the periphery of an exhaust port of a fan exhaust duct from the front.

FIG. 5 is a front view showing an engine intake duct, a CVT intake duct, and a fan intake duct from the front.

FIG. 6 is a sectional view taken along VI-VI line in FIG. 6.

FIG. 7 is a sectional view showing a state of the CVT intake duct being attached to a cabin frame of a vehicle body frame.

FIG. 8 is a perspective view showing the periphery of an intake port of the CVT intake duct from the rear.

### DESCRIPTION OF EMBODIMENTS

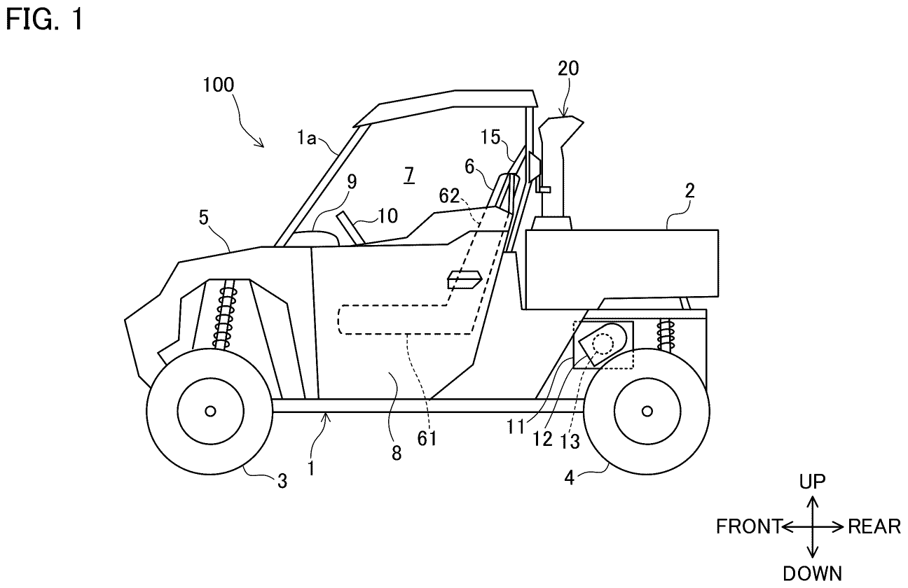

Hereinafter, an exemplary embodiment will be described in detail with reference to the drawings. FIG. 1 is a left side view of a utility vehicle 100. The utility vehicle 100 can travel off road. The utility vehicle 100 is one example of an off-road vehicle. Hereinafter, the utility vehicle 100 will also be referred to as a “vehicle 100”.

In the present disclosure, each component of the vehicle 100 will be described using a direction with respect to the vehicle 100. Specifically, a “front” means the front of the vehicle 100 in a vehicle front-rear direction, and a “rear” means the rear of the vehicle 100 in the vehicle front-rear direction. A “left” means the left when facing the front of the vehicle 100, and a “right” means the right when facing the front of the vehicle 100. A “vehicle width direction” means the width direction of the vehicle 100, and in other words, means the right-left direction of the vehicle 100 and will also be referred to as a “right-left direction”. A “vehicle-width inside” means a vehicle interior side in the vehicle width direction, and a “vehicle-width outside” means a vehicle outer side in the vehicle width direction.

The vehicle 100 includes a vehicle body frame 1, right and left front wheels 3 supporting a front portion of the vehicle body frame 1, and right and left rear wheels 4 supporting a rear portion of the vehicle body frame 1. That is, the vehicle 100 is a four-wheeled vehicle. A space between the right and left front wheels 3 is covered with a hood 5 from above. Right and left seats 6 supported by the vehicle body frame 1 are located on the rear side of the hood 5.

The seat 6 has a seating portion 61 and a back portion 62. The seating portion 61 supports the hip of an occupant. The back portion 62 supports the back of the occupant. A seatbelt 15 is attached to the vehicle body frame 1. The seatbelt 15 holds the occupant on the seat 6. The seatbelt 15 is, for example, a three-point seatbelt. The seatbelt 15 has a belt portion and an upper attachment portion through which the belt portion passes and which is attached to the vehicle body frame 1. The upper attachment portion adjusts the position of the belt portion on the shoulder of the occupant.

The vehicle body frame 1 includes hollow pipes, and the pipes are connected into the frame. The vehicle body frame 1 has a cabin frame 1a defining a vehicle interior 7 in which the seats 6 are located. An entrance is opened on each of the right and left sides of the vehicle interior 7, and is opened and closed by a door 8. A dashboard 9 is located in front of the seats 6 in the vehicle interior 7. A steering wheel 10 is attached to the dashboard 9. A luggage carrier 2 is located in rear of the cabin frame 1a. The luggage carrier 2 includes an upwardly-opened recessed loading space.

The vehicle 100 has an engine 11, a continuously variable transmission 12, a fan 13, and a duct assembly 20. The engine 11, the continuously variable transmission 12, and the fan 13 are located below the luggage carrier 2 in rear of the seats 6. Note that the vehicle 100 may have a power generator that generates power by the power of the engine 11, a battery that stores the power generated by the power generator, and the like.

The engine 11 generates power. The engine 11 is, for example, a reciprocating engine. The engine 11 has a casing, a piston, and a crankshaft. The piston and the crankshaft are located in the casing. The crankshaft is coupled to the piston to convert reciprocating motion of the piston into rotary motion.

The continuously variable transmission 12 changes the output rotation speed of the engine 11. The continuously variable transmission 12 includes a casing, a drive pulley, a driven pulley, and a belt. The drive pulley, the driven pulley, and the belt are located in the casing. The belt is wound between the drive pulley and the driven pulley.

The torque (rotative power) of the engine 11 is transmitted to the drive pulley through an input shaft. Rotation of the drive pulley is transmitted to the driven pulley through the belt. Rotation of the driven pulley is transmitted to the rear wheels 4 through an output shaft. In this manner, the continuously variable transmission 12 transmits the torque of the engine 11 to the rear wheels 4. The drive pulley is configured such that a radial position at which the belt is wound around the drive pulley is changeable. The driven pulley is configured such that a radial position at which the belt is wound around the driven pulley is changeable. Thus, the continuously variable transmission 12 continuously changes the rotation speed of the engine 11 and transmits the torque to the rear wheels 4. Note that the continuously variable transmission 12 may transmit the torque of the engine 11 to the front wheels 3 and the rear wheels 4.

The fan 13 generates an airflow to cool the engine 11. The fan 13 has a casing and an impeller. The impeller is located in the casing. The impeller is coupled, for example, to a transmission shaft. The transmission shaft is coupled to the crankshaft through a gear or the like. Thus, rotation of the crankshaft is transmitted to the transmission shaft, and the impeller rotates accordingly. By rotation of the impeller, the airflow is generated.

The duct assembly 20 is located above and below the luggage carrier 2 in rear of the seats 6. The duct assembly 20 is connected to each of the engine 11, the continuously variable transmission 12, and the fan 13. The duct assembly 20 sucks and discharges air.

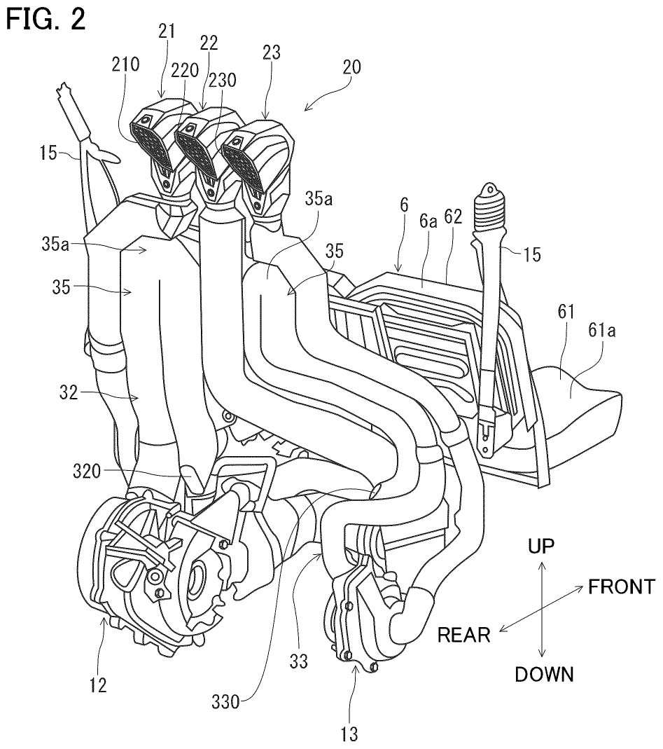

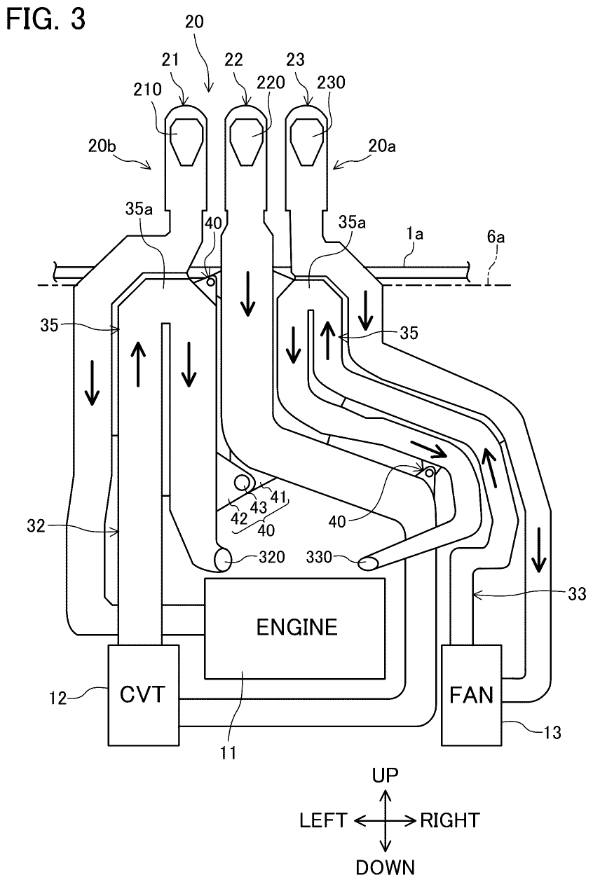

FIG. 2 is a perspective view showing the duct assembly 20 from the rear. FIG. 3 is a schematic back view showing the duct assembly 20 from the rear. In FIG. 2, the engine 11 is not shown. In FIG. 3, the upper end 6a of the seat 6 is indicated by a dash-dot-dot line, and the seatbelt 15 is not shown. In FIG. 3, the flow of air in the duct assembly 20 is indicated by arrows.

The duct assembly 20 has an engine intake duct 21, a CVT intake duct 22, a fan intake duct 23, a CVT exhaust duct 32, and a fan exhaust duct 33.

The engine intake duct 21, the CVT intake duct 22, the fan intake duct 23, the CVT exhaust duct 32, and the fan exhaust duct 33 are located in the vehicle width direction. Specifically, the engine intake duct 21, the CVT exhaust duct 32, the CVT intake duct 22, the fan exhaust duct 33, and the fan intake duct 23 are located in this order from the left to the right in the vehicle width direction.

The engine 11, the continuously variable transmission 12, and the fan 13 are located at the substantially same height. The engine 11, the continuously variable transmission 12, and the fan 13 are located in the vehicle width direction. Specifically, the continuously variable transmission 12, the engine 11, and the fan 13 are located in this order from the left to the right in the vehicle width direction.

The engine intake duct 21 is connected to the engine 11 to send external air to the engine 11. By driving of the engine 11, the inside of the engine intake duct 21 is brought into a negative pressure. Accordingly, the external air is sucked into the engine 11 through the engine intake duct 21. Then, the air sucked into the engine 11 is combusted in a combustion chamber. Thereafter, exhaust gas generated as a result of combustion in the combustion chamber is discharged to the outside through an exhaust duct (not shown).

The CVT intake duct 22 is connected to the continuously variable transmission 12 to send external air to the continuously variable transmission 12. The CVT exhaust duct 32 is connected to the continuously variable transmission 12 to discharge air from the continuously variable transmission 12. By driving of the continuously variable transmission 12, the inside of the CVT intake duct 22 is brought into a negative pressure. Accordingly, the external air is sucked into the continuously variable transmission 12 through the CVT intake duct 22. Then, the air sucked into the continuously variable transmission 12 cools the inside of the continuously variable transmission 12. Thereafter, the air in the continuously variable transmission 12 is discharged to the outside through the CVT exhaust duct 32.

The fan intake duct 23 is connected to the fan 13 to send external air to the fan 13. The fan exhaust duct 33 is connected to the fan 13 to discharge air from the fan 13. By driving of the fan 13, the inside of the fan intake duct 23 is brought into a negative pressure. Accordingly, the external air is sucked into the fan 13 through the fan intake duct 23. Then, the air sucked into the fan 13 is discharged to the outside through the fan exhaust duct 33. The air discharged through the fan exhaust duct 33 is blown to the engine 11 to cool the engine 11 from the outside.

The engine intake duct 21 extends downward so as to curve while extending from upstream to downstream of the flow of air. The CVT intake duct 22 extends downward so as to curve while extending from upstream to downstream of the flow of air. The fan intake duct 23 extends downward so as to curve while extending from upstream to downstream of the flow of air.

An intake port 210 of the engine intake duct 21 is located at a position higher than the engine 11. An intake port 220 of the CVT intake duct 22 is located at a position higher than the continuously variable transmission 12. An intake port 230 of the fan intake duct 23 is located at a position higher than the fan 13.

At least one of these three intake ports 210, 220, 230 is located at a position higher than the upper ends 6a of the seats 6. In this embodiment, each of the three intake ports 210, 220, 230 is located at the position higher than the upper ends 6a of the seats 6. Specifically, each of the three intake ports 210, 220, 230 is higher than the upper ends 6a of the back portions 62 of the seats 6. The three intake ports 210, 220, 230 are at the substantially same height. Note that each of the three intake ports 210, 220, 230 may be located at a position higher than the upper end 6a of any of the right and left seats 6.

Each of the three intake ports 210, 220, 230 is located at a position higher than the upper end of the luggage carrier 2. Specifically, each of the three intake ports 210, 220, 230 is located at a position higher than the upper opening end of the luggage carrier 2.

Each of the three intake ports 210, 220, 230 is located at a position higher than the upper end of the seatbelt 15. Specifically, each of the three intake ports 210, 220, 230 is located at a position higher than the upper attachment portion of the seatbelt 15.

Each of the three intake ports 210, 220, 230 is opened rearward. The three intake ports 210, 220, 230 are located at intervals in the vehicle width direction. The three intake ports 210, 220, 230 are located in this order from the left to the right in the vehicle width direction.

The CVT exhaust duct 32 extends upward of the continuously variable transmission 12 and then extends downward while extending from upstream to downstream of the flow of air. The fan exhaust duct 33 extends upward of the fan 13 and then extends downward while extending from upstream to downstream of the flow of air. In this manner, each of the CVT exhaust duct 32 and the fan exhaust duct 33 extends while being folded and curved in a U-shape.

The CVT exhaust duct 32 has, on the path of the CVT exhaust duct 32, a curved portion 35 extending upward and then extending downward while extending from upstream to downstream. The fan exhaust duct 33 has, on the path of the fan exhaust duct 33, a curved portion 35 extending upward and then extending downward while extending from upstream to downstream. An upper end portion 35a of the curved portion 35 is located at a position higher than seating surfaces 61a of the seating portions 61 of the seats 6.

An exhaust port 320 of the CVT exhaust duct 32 is located at a position higher than the continuously variable transmission 12. An exhaust port 330 of the fan exhaust duct 33 is located at a position higher than the fan 13. The intake port 230 of the fan intake duct 23 is located at a position higher than the exhaust port 330 of the fan exhaust duct 33.

The two exhaust ports 320, 330 are at positions above the engine 11. The two exhaust ports 320, 330 face the engine 11. Thus, air discharged through the two exhaust ports 320, 330 is blown to the casing of the engine 11 to cool the engine 11.

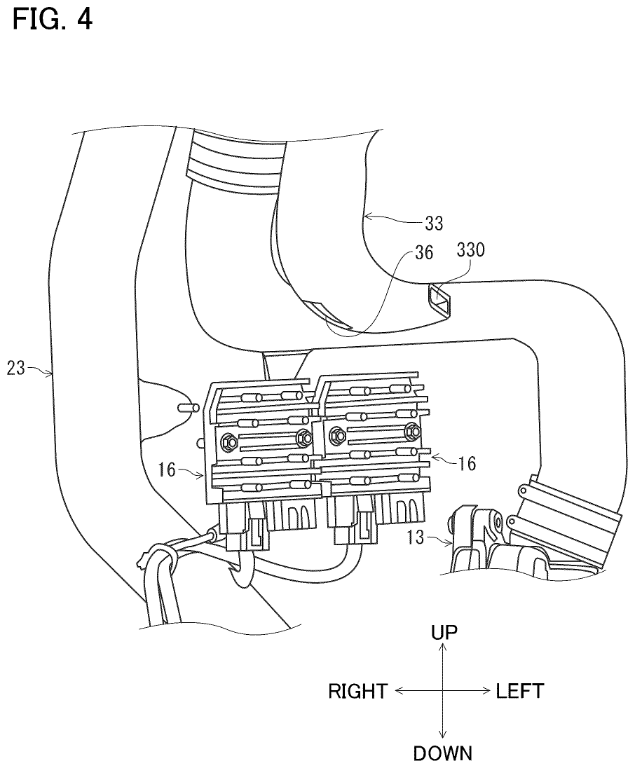

FIG. 4 is a perspective view showing the periphery of the exhaust port 330 of the CVT exhaust duct 32 from the front. The fan exhaust duct 33 has, on the path of the fan exhaust duct 33, a through-hole 36 through which air is discharged. The through-hole 36 is at a position in the vicinity of the exhaust port 330.

The vehicle 100 further includes a voltage regulator 16. The voltage regulator 16 is one example of a cooling target component of the present disclosure. The voltage regulator 16 is a device that adjusts and rectifies voltage generated by a generator to supply the voltage to a battery.

The through-hole 36 is located at a position facing the voltage regulator 16. Specifically, the through-hole 36 is located above the voltage regulator 16. Thus, air discharged through the through-hole 36 is blown to the voltage regulator 16 to cool the voltage regulator 16.

Note that the cooling target component may be a component other than the voltage regulator. The cooling target component may be, for example, a heat generating component such as an electronic component or the engine 11.

As shown in FIG. 3, the CVT intake duct 22, the fan intake duct 23, and the fan exhaust duct 33 are integrated. Specifically, the CVT intake duct 22, the fan intake duct 23, and the fan exhaust duct 33 are integrally molded. The fan exhaust duct 33 is located between the CVT intake duct 22 and the fan intake duct 23. Hereinafter, the integrated CVT intake duct 22, fan intake duct 23, and fan exhaust duct 33 will also be referred to as a first duct group 20a.

The engine intake duct 21 and the CVT exhaust duct 32 are integrated. Specifically, the engine intake duct 21 and the CVT exhaust duct 32 are integrally molded. Hereinafter, the integrated engine intake duct 21 and CVT exhaust duct 32 will also be referred to as a second duct group 20b.

The CVT intake duct 22 and the CVT exhaust duct 32 are fastened together. That is, the first duct group 20a and the second duct group 20b are fastened together. Specifically, the CVT intake duct 22 and the CVT exhaust duct 32 are fixed to each other with two co-fastening portions 40. The two co-fastening portions 40 include a first co-fastening portion 40 and a second co-fastening portion 40.

The first co-fastening portion 40 is located below, and the second co-fastening portion 40 is located above. Specifically, the first co-fastening portion 40 is at a position in the vicinity of the exhaust port 320 of the CVT exhaust duct 32. The second co-fastening portion 40 is at a position in the vicinity of the upper end portion 35a of the curved portion 35 of the CVT exhaust duct 32.

The co-fastening portion 40 has a first attachment plate 41, a second attachment plate 42, and a fastening member 43. The first attachment plate 41 is fixed to the CVT intake duct 22. The second attachment plate 42 is fixed to the CVT exhaust duct 32. The first attachment plate 41 and the second attachment plate 42 overlap with each other, and the fastening member 43 penetrates the overlapping portions of the first attachment plate 41 and the second attachment plate 42 and fastens the first attachment plate 41 and the second attachment plate 42. The fastening member 43 is, for example, a bolt and a nut.

The CVT intake duct 22 and the fan exhaust duct 33 may be further fastened together. Specifically, the CVT intake duct 22 and the fan exhaust duct 33 are fixed to each other with a co-fastening portion 40. Specifically, the co-fastening portion 40 has a first attachment plate fixed to the CVT intake duct 22, a second attachment plate fixed to the fan exhaust duct 33, and a fastening member fastening the first attachment plate and the second attachment plate.

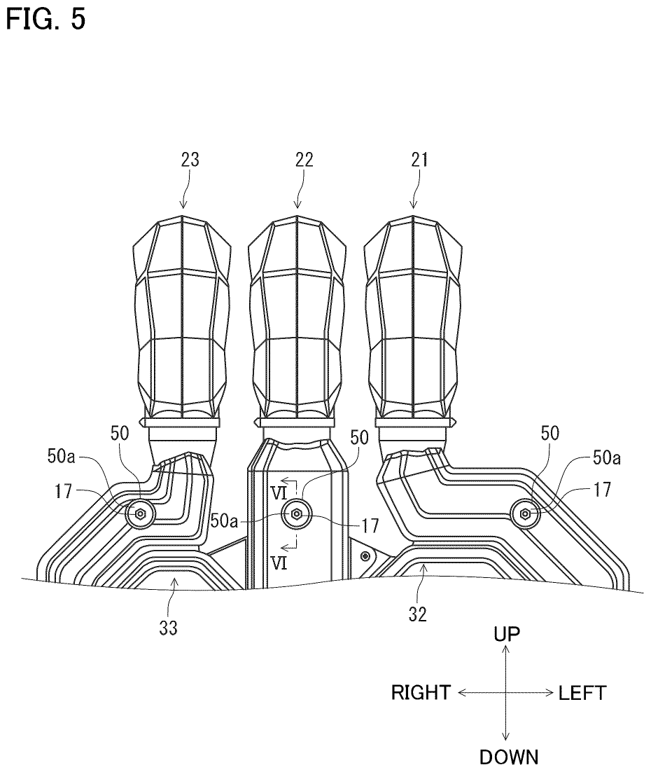

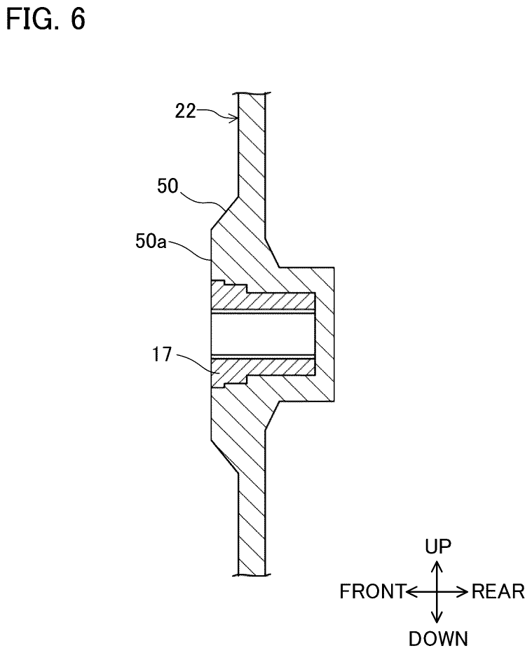

FIG. 5 is a front view showing the engine intake duct 21, the CVT intake duct 22, and the fan intake duct 23 from the front. FIG. 6 is a sectional view taken along VI-VI line in FIG. 5.

The vehicle 100 further has a nut 17. The nut 17 is embedded in the outer surface 50a of each of the engine intake duct 21, the CVT intake duct 22, and the fan intake duct 23 on the path thereof.

Specifically, the CVT intake duct 22 has a bulging portion 50 in an upper front region of the outer surface of the CVT intake duct 22. The nut 17 is embedded in the bulging portion 50. The nut 17 is molded integrally with the CVT intake duct 22, for example, by casting or the like.

The nut 17 is flush with the outer surface 50a of the bulging portion 50. The outer surface 50a of the bulging portion 50 is flat. The surface of the nut 17 is flat. The outer surface 50a of the bulging portion 50 and the surface of the nut 17 are on the same plane.

A bulging portion 50 of the engine intake duct 21 and a bulging portion 50 of the fan intake duct 23 have configurations similar to that of the bulging portion 50 of the CVT intake duct 22. That is, in the engine intake duct 21, the nut 17 is flush with the outer surface 50a of the bulging portion 50. In the fan intake duct 23, the nut 17 is flush with the outer surface 50a of the bulging portion 50.

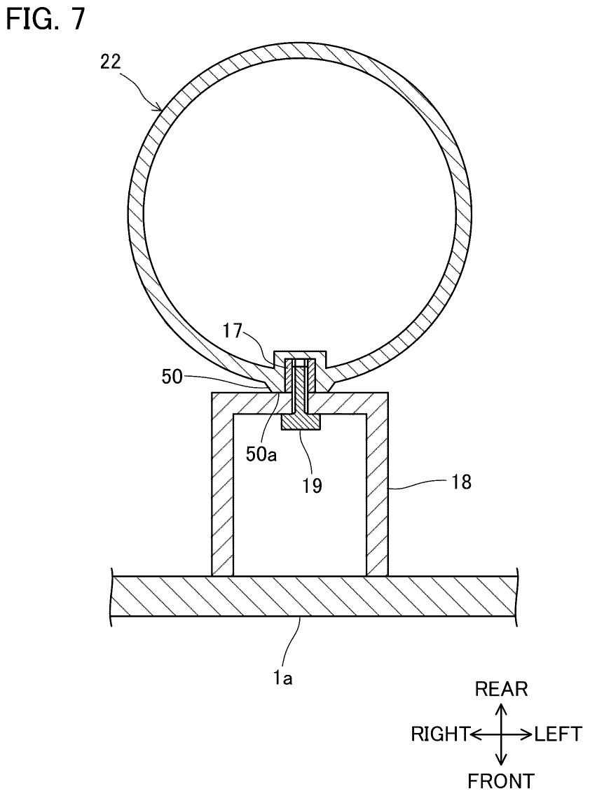

FIG. 7 is a sectional view showing a state of the CVT intake duct 22 being attached to the cabin frame 1a of the vehicle body frame 1. The CVT intake duct 22 is attached to the cabin frame 1a through a bracket 18.

Specifically, the bracket 18 is fixed to the cabin frame 1a. In a state of the outer surface 50a of the bulging portion 50 of the CVT intake duct 22 contacting the bracket 18, a bolt 19 is fastened through the bracket 18 to the nut 17 embedded in the bulging portion 50. In this manner, the CVT intake duct 22 is attached to the bracket 18 by fastening the bolt 19. At this time, in a state of the outer surface 50a of the bulging portion 50 and the surface of the nut 17 contacting the bracket 18, the CVT intake duct 22 is attached to the bracket 18.

Note that the engine intake duct 21 and the fan intake duct 23 are attached to the cabin frame 1a similarly to the CVT intake duct 22. That is, the engine intake duct 21 and the fan intake duct 23 are attached to the cabin frame 1a through brackets 18.

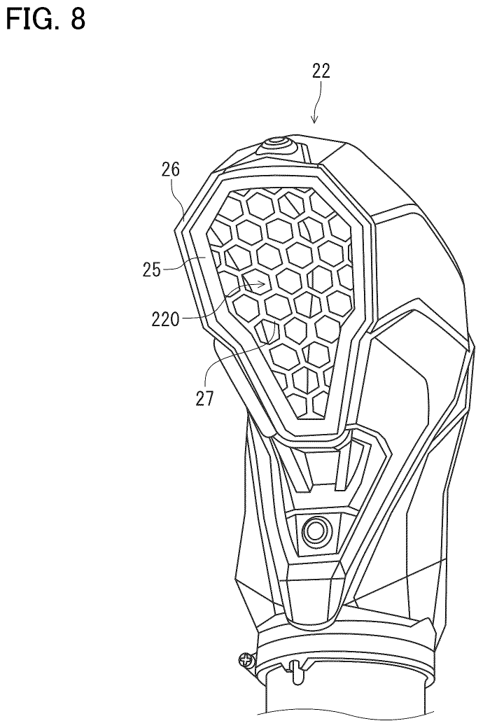

FIG. 8 is a perspective view showing the periphery of the intake port 220 of the CVT intake duct 22 from the rear. The opening end of the CVT intake duct 22 on the intake port 220 side has a filter attachment surface 25. A filter (not shown) is attachable to the filter attachment surface 25. The filter is attached to the filter attachment surface 25, for example, with an adhesive sheet. The filter blocks entrance of a foreign substance larger than a filter cell.

The filter attachment surface 25 extends in the circumferential direction of the opening end. The filter attachment surface 25 faces rearward. The filter attachment surface 25 has, at the outer peripheral edge thereof, an annular wall portion 26. The wall portion 26 stands on the filter attachment surface 25 and protrudes rearward. When the filter is attached to the filter attachment surface 25, the wall portion 26 reduces a probability of the filter protruding outward of the outer periphery of the filter attachment surface 25.

In this example, a grid member 27 having holes is attached to the intake port 220. The grid member 27 blocks entrance of a foreign substance larger than the hole of the grid member 27. The hole of the grid member 27 is larger than the filter cell. Note that the grid member 27 may be omitted.

Similarly, each of the opening end of the engine intake duct 21 on the intake port 210 side and the opening end of the fan intake duct 23 on the intake port 230 side has a filter attachment surface 25. Thus, a filter is attachable to the filter attachment surface 25.

According to the vehicle 100 described above, at least one of the intake port 210 of the engine intake duct 21, the intake port 220 of the CVT intake duct 22, or the intake port 230 of the fan intake duct 23 is located at the position higher than the upper ends 6a of the seats 6. This can reduce a probability of a foreign substance being sucked through at least one intake port.

Specifically, when the vehicle 100 travels on a marshy area, a boggy area, or the like, a foreign substance contained in the marshy area or the boggy area is kicked up by the wheels and is scattered. The foreign substance includes, for example, substances contained in the marshy area or the boggy area, such as water, mud, sand, and rocks. The scattered foreign substance is less likely to reach the face of the occupant. Thus, at least one intake port is located at the position higher than the positions of the upper ends 6a of the seats 6 corresponding to the position of the face of the occupant, so that a probability of the foreign substance being sucked through at least one intake port can be reduced.

Since the intake port 210 of the engine intake duct 21 is located at the position higher than the upper ends 6a of the seats 6, a probability of the foreign substance being sucked through the intake port 210 of the engine intake duct 21 can be reduced. Thus, entrance of the foreign substance into the engine 11 can be reduced, and degradation of the performance of the engine 11 can be reduced.

Since the intake port 220 of the CVT intake duct 22 is located at the position higher than the upper ends 6a of the seats 6, a probability of the foreign substance being sucked through the intake port 220 of the CVT intake duct 22 can be reduced. Thus, entrance of the foreign substance into the continuously variable transmission 12 can be reduced, and degradation of the performance of the continuously variable transmission 12 can be reduced.

Since the intake port 230 of the fan intake duct 23 is located at the position higher than the upper ends 6a of the seats 6, a probability of the foreign substance being sucked through the intake port 230 of the fan intake duct 23 can be reduced. Thus, entrance of the foreign substance into the fan 13 can be reduced, and degradation of the performance of the fan 13 can be reduced.

Since the intake port 230 of the fan intake duct 23 is located at the position higher than the exhaust port 330 of the fan exhaust duct 33, a probability of the foreign substance being sucked through the intake port 230 of the fan intake duct 23 can be reduced. Thus, entrance of the foreign substance into the fan 13 can be reduced, and degradation of the performance of the fan 13 can be reduced.

Since the fan exhaust duct 33 has the through-hole 36, the component facing the through-hole 36 can be cooled with air discharged through the through-hole 36.

Since the through-hole 36 is located at the position facing the cooling target component, the cooling target component can be cooled with air discharged through the through-hole 36.

Since the cooling target component is the voltage regulator 16, the voltage regulator 16 can be cooled.

Since the nut 17 is embedded so as to be flush with the outer surface 50a of the CVT intake duct 22, the CVT intake duct 22 can be attached in a stable posture to the bracket 18 when the CVT intake duct 22 is attached to the bracket 18 by fastening the bolt 19 to the nut 17 through the bracket 18 fixed to the vehicle body frame 1.

Specifically, in a case where the nut 17 protrudes from the outer surface 50a of the CVT intake duct 22, when the CVT intake duct 22 is attached to the bracket 18, the bracket 18 contacts the nut 17 and separates from the outer surface 50a of the CVT intake duct 22. Thus, the posture of the CVT intake duct 22 when the CVT intake duct 22 is attached to the bracket 18 is unstable. On the other hand, in the present disclosure, since the nut 17 is flush with the outer surface 50a of the CVT intake duct 22, the bracket 18 contacts the nut 17 and the outer surface 50a of the CVT intake duct 22, and therefore, the posture of the CVT intake duct 22 when the CVT intake duct 22 is attached to the bracket 18 is stabilized.

Similarly, since the nut 17 is embedded so as to be flush with the outer surface 50a of the engine intake duct 21, the engine intake duct 21 can be attached in a stable posture to the bracket 18 when the engine intake duct 21 is attached to the bracket 18.

Similarly, since the nut 17 is embedded so as to be flush with the outer surface 50a of the fan intake duct 23, the fan intake duct 23 can be attached in a stable posture to the bracket 18 when the fan intake duct 23 is attached to the bracket 18.

Since the CVT intake duct 22, the fan intake duct 23, and the fan exhaust duct 33 are integrated, the CVT intake duct 22, the fan intake duct 23, and the fan exhaust duct 33 can be easily assembled with the vehicle 100.

Since the engine intake duct 21 and the CVT exhaust duct 32 are integrated, the engine intake duct 21 and the CVT exhaust duct 32 can be easily assembled with the vehicle 100.

Since the CVT intake duct 22 and the CVT exhaust duct 32 are fastened together, the integrated CVT intake duct 22, fan intake duct 23, and fan exhaust duct 33 (first duct group 20a) can be fixed to the integrated engine intake duct 21 and CVT exhaust duct 32 (second duct group 20b). Thus, the postures of all the ducts are stabilized.

Each of the opening end of the engine intake duct 21 on the intake port 210 side, the opening end of the CVT intake duct 22 on the intake port 220 side, and the opening end of the fan intake duct 23 on the intake port 230 side has the filter attachment surface 25. Thus, the filter can be attached to the filter attachment surface 25.

The three intake ports 210, 220, 230 are located at the positions higher than the upper end of the luggage carrier 2. Thus, a probability of the foreign substance being sucked through the three intake ports 210, 220, 230 can be reduced.

The three intake ports 210, 220, 230 are located at the positions higher than the upper end of the seatbelt 15. Thus, a probability of the foreign substance being sucked through the three intake ports 210, 220, 230 can be reduced.

The three intake ports 210, 220, 230 are opened rearward. Thus, a probability of the foreign substance scattered rearward being sucked through the three intake ports 210, 220, 230 while the vehicle 100 is traveling forward can be reduced.

The three intake ports 210, 220, 230 are located at intervals in the vehicle width direction. Thus, the three intake ports 210, 220, 230 can be dispersedly located in the vehicle width direction, and a probability of the foreign substance being sucked through all the intake ports can be reduced.

Since the CVT exhaust duct 32 has the curved portion 35, the foreign substance is less likely to flow to upstream beyond the curved portion 35 even when the foreign substance enters the exhaust port 320 of the CVT exhaust duct 32. Specifically, even when the foreign substance enters the exhaust port 320, the foreign substance needs to move upward until reaching the upper end portion 35a of the curved portion 35. Thus, due to the force of gravity, the foreign substance is less likely to reach the upper end portion 35a. Thus, the backflow of the foreign substance in the CVT exhaust duct 32 can be reduced.

Since the upper end portion 35a of the curved portion 35 is located at the position higher than the seating surfaces 61a of the seats 6, the backflow of the foreign substance in the CVT exhaust duct 32 can be reduced.

Similarly, since the fan exhaust duct 33 has the curved portion 35, the foreign substance is less likely to flow to upstream beyond the curved portion 35 even when the foreign substance enters the exhaust port 330 of the fan exhaust duct 33. Thus, the backflow of the foreign substance in the exhaust duct can be reduced.

Since the upper end portion 35a of the curved portion 35 is located at the position higher than the seating surfaces 61a of the seats 6, the backflow of the foreign substance in the fan exhaust duct 33 can be reduced.

### <<First Modification>>

Next, a vehicle (one example of the off-road vehicle) according to a first modification will be described mainly with reference to FIGS. 1, 2, and 3. Unlike the vehicle 100 according to the embodiment, the vehicle according to the first modification is configured regardless of the heights of the intake port 220 of the CVT intake duct 22 and the intake port 230 of the fan intake duct 23. In the first modification, the same reference numerals as those of the first embodiment indicate the same components as those of the first embodiment, and therefore, description thereof will be omitted.

The vehicle according to the first modification includes the seats 6, the engine 11, and the engine intake duct 21. The engine intake duct 21 is connected to the engine 11 to send external air to the engine 11. The intake port 210 of the engine intake duct 21 is located at the position higher than the upper ends 6a of the seats 6.

According to the vehicle of the first modification, the intake port 210 of the engine intake duct 21 is located at the position higher than the upper ends 6a of the seats 6. Thus, a probability of the foreign substance being sucked through the intake port 210 of the engine intake duct 21 can be reduced. As a result, entrance of the foreign substance into the engine 11 can be reduced, and degradation of the performance of the engine 11 can be reduced.

Note that description of other configurations, features, and effects will be omitted, and the description of the vehicle 100 according to the embodiment can also be used for describing the vehicle according to the first modification.

### OTHER EMBODIMENTS

The embodiment has been described above as an example of the technique disclosed in the present application. However, the technique in the present disclosure is not limited to above, and is also applicable to embodiments to which changes, replacements, additions, omissions, and the like are made as necessary. The components described above in the embodiment may be combined to form a new embodiment. The components shown in the attached drawings and described in detail may include not only components essential for solving the problems, but also components that are provided for describing an example of the above-described technique and are not essential for solving the problems. Thus, description of these non-essential components in detail and illustration of these components in the attached drawings shall not be interpreted that these non-essential components are essential.

In the embodiment above, the intake port 210 of the engine intake duct 21, the intake port 220 of the CVT intake duct 22, and the intake port 230 of the fan intake duct 23 are located at the positions higher than the upper ends 6a of the seats 6, but at least one of the three intake ports 210, 220, 230 only needs to be located at the position higher than the upper ends 6a of the seats 6.

In the embodiment above, the seats 6 are in one line, but may be in two or more lines. At least one of the three intake ports 210, 220, 230 only needs to be located at the position higher than the upper end 6a of at least one of the seats 6.

In the embodiment above, the seat 6 has the seating portion 61 and the back portion 62, but may further have a headrest attached to the back portion 62. In this case, at least one of the three intake ports 210, 220, 230 only needs to be located at a position higher than the upper end of the headrest of the seat 6.

In the embodiment above, each of the three intake ports 210, 220, 230 is located at the position higher than the upper end of the luggage carrier 2, but at least one of the three intake ports 210, 220, 230 may be located at the position higher than the upper end of the luggage carrier 2.

In the embodiment above, the vehicle 100 has the luggage carrier 2, but the luggage carrier 2 may be omitted.

In the embodiment above, each of the three intake ports 210, 220, 230 is located at the position higher than the upper end of the seatbelt 15, but at least one of the three intake ports 210, 220, 230 may be located at the position higher than the upper end of the seatbelt 15. Alternatively, at least one of the three intake ports 210, 220, 230 may be located at a position lower than the upper end of the seatbelt 15.

In the embodiment above, each of the three intake ports 210, 220, 230 is opened rearward, but at least one of the three intake ports 210, 220, 230 may be opened rearward. Alternatively, at least one of the three intake ports 210, 220, 230 may be opened forward.

In the embodiment above, the three intake ports 210, 220, 230 are located at intervals in the vehicle width direction, but may be located at intervals in the front-rear direction.

In the embodiment above, the three intake ports 210, 220, 230 are at the substantially same height, but may be at different heights.

In the embodiment above, the intake port 230 of the fan intake duct 23 is located at the position higher than the exhaust port 330 of the fan exhaust duct 33, but may be located at a position lower than the exhaust port 330 of the fan exhaust duct 33.

In the embodiment above, each of the CVT exhaust duct 32 and the fan exhaust duct 33 has the curved portion 35, but at least one of the CVT exhaust duct 32 or the fan exhaust duct 33 only needs to have the curved portion 35.

In the embodiment above, the fan exhaust duct 33 has the through-hole 36, but at least one of the CVT exhaust duct 32 or the fan exhaust duct 33 may have the through-hole 36. Alternatively, the through-hole 36 may be omitted.

In the embodiment above, the CVT intake duct 22, the fan intake duct 23, and the fan exhaust duct 33 are integrated, but may be separated from each other. The engine intake duct 21 and the CVT exhaust duct 32 are integrated, but may be separated from each other.

In the embodiment above, the CVT intake duct 22 and the CVT exhaust duct 32 are fastened together, but are not necessarily fastened together.

In the embodiment above, the CVT intake duct 22 and the fan exhaust duct 33 are fastened together, but are not necessarily fastened together.

In the embodiment above, the nut 17 is embedded in the outer surface 50a of each of the engine intake duct 21, the CVT intake duct 22, and the fan intake duct 23 on the path thereof, but may be embedded in the outer surface 50a of at least one of the engine intake duct 21, the CVT intake duct 22, or the fan intake duct 23 on the path thereof.

In the embodiment above, the nut 17 is flush with the outer surface 50a, but may protrude from the outer surface 50a or may be recessed from the outer surface 50a.

In the embodiment above, each of the opening end of the engine intake duct 21 on the intake port 210 side, the opening end of the CVT intake duct 22 on the intake port 220 side, and the opening end of the fan intake duct 23 on the intake port 230 side has the filter attachment surface 25, but at least one of the opening end of the engine intake duct 21 on the intake port 210 side, the opening end of the CVT intake duct 22 on the intake port 220 side, or the opening end of the fan intake duct 23 on the intake port 230 side only needs to have the filter attachment surface 25. Alternatively, the filter attachment surface 25 may be omitted.

The technique disclosed here may be applied to an off-road vehicle other than the utility vehicle 100.

### [Aspects]

The embodiment above is a specific example of the following aspects.

### (First Aspect)

The utility vehicle 100 (off-road vehicle) is the utility vehicle 100 including the seats 6, the engine 11, the continuously variable transmission 12, and the fan 13, which further includes the engine intake duct 21 connected to the engine 11 to send external air to the engine 11, the CVT intake duct 22 connected to the continuously variable transmission 12 to send external air to the continuously variable transmission 12, and the fan intake duct 23 connected to the fan 13 to send external air to the fan 13. At least one of the intake port 210 of the engine intake duct 21, the intake port 220 of the CVT intake duct 22, or the intake port 230 of the fan intake duct 23 is located at the position higher than the upper ends 6a of the seats 6.

According to this configuration, at least one of the intake port 210 of the engine intake duct 21, the intake port 220 of the CVT intake duct 22, or the intake port 230 of the fan intake duct 23 is located at the position higher than the upper ends 6a of the seats 6. This can reduce a probability of the foreign substance being sucked through at least one intake port.

### (Second Aspect)

The utility vehicle 100 (off-road vehicle) is the utility vehicle 100 including the seats 6 and the engine 11, which further includes the engine intake duct 21 connected to the engine 11 to send external air to the engine 11. The intake port 210 of the engine intake duct 21 is located at the position higher than the upper ends 6a of the seats 6. According to this configuration, the intake port 210 of the engine intake duct 21 is located at the position higher than the upper ends 6a of the seats 6. Thus, a probability of the foreign substance being sucked through the intake port 210 of the engine intake duct 21 can be reduced. Thus, entrance of the foreign substance into the engine 11 can be reduced, and degradation of the performance of the engine 11 can be reduced.

### (Third Aspect)

In the utility vehicle 100 according to the first or second aspect, the intake port 210 of the engine intake duct 21 is located at the position higher than the upper ends 6a of the seats 6.

According to this configuration, since the intake port 210 of the engine intake duct 21 is located at the position higher than the upper ends 6a of the seats 6, a probability of the foreign substance being sucked through the intake port 210 of the engine intake duct 21 can be reduced. Thus, entrance of the foreign substance into the engine 11 can be reduced, and degradation of the performance of the engine 11 can be reduced.

### (Fourth Aspect)

In the utility vehicle 100 according to any one of the first to third aspects, the intake port 220 of the CVT intake duct 22 is located at the position higher than the upper ends 6a of the seats 6.

According to this configuration, since the intake port 220 of the CVT intake duct 22 is located at the position higher than the upper ends 6a of the seats 6, a probability of the foreign substance being sucked through the intake port 220 of the CVT intake duct 22 can be reduced. Thus, entrance of the foreign substance into the continuously variable transmission 12 can be reduced, and degradation of the performance of the continuously variable transmission 12 can be reduced.

### (Fifth Aspect)

In the utility vehicle 100 according to any one of the first to fourth aspects, the intake port 230 of the fan intake duct 23 is located at the position higher than the upper ends 6a of the seats 6.

According to this configuration, since the intake port 230 of the fan intake duct 23 is located at the position higher than the upper ends 6a of the seats 6, a probability of the foreign substance being sucked through the intake port 230 of the fan intake duct 23 can be reduced. Thus, entrance of the foreign substance into the fan 13 can be reduced, and degradation of the performance of the fan 13 can be reduced.

### (Sixth Aspect)

The utility vehicle 100 according to any one of the first to fifth aspects further includes the fan exhaust duct 33 connected to the fan 13 to discharge air from the fan 13, and the intake port 230 of the fan intake duct 23 is located at the position higher than the exhaust port 330 of the fan exhaust duct 33.

According to this configuration, since the intake port 230 of the fan intake duct 23 is located at the position higher than the exhaust port 330 of the fan exhaust duct 33, a probability of the foreign substance being sucked through the intake port 230 of the fan intake duct 23 can be reduced. Thus, entrance of the foreign substance into the fan 13 can be reduced, and degradation of the performance of the fan 13 can be reduced.

### (Seventh Aspect)

The utility vehicle 100 according to any one of the first to sixth aspects further includes the CVT exhaust duct 32 connected to the continuously variable transmission 12 to discharge air from the continuously variable transmission 12, and the fan exhaust duct 33 connected to the fan 13 to discharge air from the fan 13, and at least one of the CVT exhaust duct 32 or the fan exhaust duct 33 has, on the path thereof, the through-hole 36 through which air is discharged.

According to this configuration, since at least one of the CVT exhaust duct 32 or the fan exhaust duct 33 has the through-hole 36, the component facing the through-hole 36 can be cooled with air discharged through the through-hole 36.

### (Eighth Aspect)

The utility vehicle 100 according to any one of the first to seventh aspects further includes the cooling target component, and the through-hole 36 is located at the position facing the cooling target component.

According to this configuration, since the through-hole 36 is located at the position facing the cooling target component, the cooling target component can be cooled with air discharged through the through-hole 36.

### (Ninth Aspect)

In the utility vehicle 100 according to any one of the first to eighth aspects, the cooling target component is the voltage regulator 16.

According to this configuration, since the cooling target component is the voltage regulator 16, the voltage regulator 16 can be cooled.

### (Tenth Aspect)

The utility vehicle 100 according to any one of the first to ninth aspects further includes the nut 17 embedded in the outer surface 50a of at least one of the engine intake duct 21, the CVT intake duct 22, or the fan intake duct 23 on the path thereof, and the nut 17 is flush with the outer surface 50a.

According to this configuration, since the nut 17 is embedded so as to be flush with the outer surface 50a of the intake duct, the intake duct can be attached in a stable posture to the bracket 18 when the intake duct is attached to the bracket 18 by fastening the bolt 19 to the nut 17 through the bracket 18 fixed to the vehicle body frame 1.

### (Eleventh Aspect)

The utility vehicle 100 according to any one of the first to tenth aspects further includes the fan exhaust duct 33 connected to the fan 13 to discharge air from the fan 13, and the CVT intake duct 22, the fan intake duct 23, and the fan exhaust duct 33 are integrated.

According to this configuration, since the CVT intake duct 22, the fan intake duct 23, and the fan exhaust duct 33 are integrated, the CVT intake duct 22, the fan intake duct 23, and the fan exhaust duct 33 can be easily assembled with the vehicle 100.

### (Twelfth Aspect)

The utility vehicle 100 according to any one of the first to eleventh aspects further includes the CVT exhaust duct 32 connected to the continuously variable transmission 12 to discharge air from the continuously variable transmission 12, and the engine intake duct 21 and the CVT exhaust duct 32 are integrated.

According to this configuration, since the engine intake duct 21 and the CVT exhaust duct 32 are integrated, the engine intake duct 21 and the CVT exhaust duct 32 can be easily assembled with the vehicle 100.

### (Thirteenth Aspect)

The utility vehicle 100 according to any one of the first to twelfth aspects further includes the CVT exhaust duct 32 connected to the continuously variable transmission 12 to discharge air from the continuously variable transmission 12, the engine intake duct 21 and the CVT exhaust duct 32 are integrated, and the CVT intake duct 22 and the CVT exhaust duct 32 are fastened together.

According to this configuration, since the CVT intake duct 22 and the CVT exhaust duct 32 are fastened together, the integrated CVT intake duct 22, fan intake duct 23, and fan exhaust duct 33 can be fixed to the integrated engine intake duct 21 and CVT exhaust duct 32. Thus, the postures of all the ducts are stabilized.

### (Fourteenth Aspect)

In the utility vehicle 100 according to any one of the first to thirteenth aspects, at least one of the opening end of the engine intake duct 21 on the intake port 210 side, the opening end of the CVT intake duct 22 on the intake port 220 side, or the opening end of the fan intake duct 23 on the intake port 230 side has the filter attachment surface 25.

According to this configuration, at least one of the opening end of the engine intake duct 21 on the intake port 210 side, the opening end of the CVT intake duct 22 on the intake port 220 side, or the opening end of the fan intake duct 23 on the intake port 230 side has the filter attachment surface 25. Thus, the filter can be attached to the filter attachment surface 25 of at least one opening end.

### (Fifteenth Aspect)

The utility vehicle 100 according to any one of the first to fourteenth aspects further includes the luggage carrier 2 located in rear of the seats 6, and the at least one of the intake ports is located at the position higher than the upper end of the luggage carrier 2.

According to this configuration, at least one intake port is located at the position higher than the upper end of the luggage carrier 2. Thus, a probability of the foreign substance being sucked through the at least one intake port can be reduced.

### (Sixteenth Aspect)

The utility vehicle 100 according to any one of the first to fifteenth aspects further includes the seatbelt 15, and the at least one of the intake ports is located at the position higher than the upper end of the seatbelt 15.

According to this configuration, at least one intake port is located at the position higher than the upper end of the seatbelt 15. Thus, a probability of the foreign substance being sucked through the at least one intake port can be reduced.

### (Seventeenth Aspect)

In the utility vehicle 100 according to any one of the first to sixteenth aspects, the at least one of the intake ports is opened rearward.

According to this configuration, at least one intake port is opened rearward. Thus, a probability of the foreign substance scattered rearward being sucked through the at least one intake port while the utility vehicle 100 is traveling forward can be reduced.

### (Eighteenth Aspect)

In the utility vehicle 100 according to any one of the first to seventeenth aspects, the intake port 210 of the engine intake duct 21, the intake port 220 of the CVT intake duct 22, and the intake port 230 of the fan intake duct 23 are located at intervals in the vehicle width direction.

According to this configuration, the intake port 210 of the engine intake duct 21, the intake port 220 of the CVT intake duct 22, and the intake port 230 of the fan intake duct 23 are located at intervals in the vehicle width direction. Thus, these three intake ports can be dispersedly located in the vehicle width direction, and a probability of the foreign substance being sucked through all the intake ports can be reduced.

### (Nineteenth Aspect)

The utility vehicle 100 according to any one of the first to eighteenth aspects further includes the CVT exhaust duct 32 connected to the continuously variable transmission 12 to discharge air from the continuously variable transmission 12, and the fan exhaust duct 33 connected to the fan 13 to discharge air from the fan 13, and at least one of the CVT exhaust duct 32 or the fan exhaust duct 33 has, on the path thereof, the curved portion 35 extending upward and then extending downward while extending from upstream to downstream.

According to this configuration, since at least one exhaust duct has the curved portion 35, the foreign substance is less likely to flow to upstream beyond the curved portion 35 even when the foreign substance enters the exhaust port of the exhaust duct. The backflow of the foreign substance in the exhaust duct can be reduced.

### (Twentieth Aspect)

In the utility vehicle 100 according to any one of the first to nineteenth aspects, the upper end portion 35a of the curved portion 35 is located at the position higher than the seating surfaces 61a of the seats 6.

According to this configuration, since the upper end portion 35a of the curved portion 35 is located at the position higher than the seating surfaces 61a of the seats 6, the backflow of the foreign substance in the exhaust duct can be reduced.

What is claimed:

1. An off-road vehicle including a seat, an engine, a continuously variable transmission, and a fan, comprising:
an engine intake duct connected to the engine to send external air to the engine;
a CVT intake duct connected to the continuously variable transmission to send external air to the continuously variable transmission; and
a fan intake duct connected to the fan to send external air to the fan,
wherein at least one of an intake port of the engine intake duct, an intake port of the CVT intake duct, or an intake port of the fan intake duct is located at a position higher than an upper end of the seat.

2. An off-road vehicle including a seat and an engine, comprising:
an engine intake duct connected to the engine to send external air to the engine,
wherein an intake port of the engine intake duct is located at a position higher than an upper end of the seat.

3. The off-road vehicle according to claim 1, wherein
the intake port of the engine intake duct is located at a position higher than the upper end of the seat.

4. The off-road vehicle according to claim 1, wherein
the intake port of the CVT intake duct is located at a position higher than the upper end of the seat.

5. The off-road vehicle according to claim 1, wherein
the intake port of the fan intake duct is located at a position higher than the upper end of the seat.

6. The off-road vehicle according to claim 1, further comprising:
a fan exhaust duct connected to the fan to discharge air from the fan,
wherein the intake port of the fan intake duct is located at a position higher than an exhaust port of the fan exhaust duct.

7. The off-road vehicle according to claim 1, further comprising:
a CVT exhaust duct connected to the continuously variable transmission to discharge air from the continuously variable transmission; and
a fan exhaust duct connected to the fan to discharge air from the fan,
wherein at least one of the CVT exhaust duct or the fan exhaust duct has, on a path thereof, a through-hole through which air is discharged.

8. The off-road vehicle according to claim 7, further comprising:
a cooling target component,
wherein the through-hole is located at a position facing the cooling target component.

9. The off-road vehicle according to claim 8, wherein
the cooling target component is a voltage regulator.

10. The off-road vehicle according to claim 1, further comprising:
a nut embedded in an outer surface of at least one of the engine intake duct, the CVT intake duct, or the fan intake duct on a path thereof,
wherein the nut is flush with the outer surface.

11. The off-road vehicle according to claim 1, further comprising:
a fan exhaust duct connected to the fan to discharge air from the fan,
wherein the CVT intake duct, the fan intake duct, and the fan exhaust duct are integrated.

12. The off-road vehicle according to claim 1, further comprising:
a CVT exhaust duct connected to the continuously variable transmission to discharge air from the continuously variable transmission,
wherein the engine intake duct and the CVT exhaust duct are integrated.

13. The off-road vehicle according to claim 11, further comprising:
a CVT exhaust duct connected to the continuously variable transmission to discharge air from the continuously variable transmission,
wherein the engine intake duct and the CVT exhaust duct are integrated, and
the CVT intake duct and the CVT exhaust duct are fastened together.

14. The off-road vehicle according to claim 1, wherein
at least one of an opening end of the engine intake duct on an intake port side, an opening end of the CVT intake duct on an intake port side, or an opening end of the fan intake duct on an intake port side has a filter attachment surface.

15. The off-road vehicle according to claim 1, further comprising:
a luggage carrier located in rear of the seat,
wherein the at least one of the intake ports is located at a position higher than an upper end of the luggage carrier.

16. The off-road vehicle according to claim 1, further comprising:
a seatbelt,
wherein the at least one of the intake ports is located at a position higher than an upper end of the seatbelt.

17. The off-road vehicle according to claim 1, wherein
the at least one of the intake ports is opened rearward.

18. The off-road vehicle according to claim 1, wherein
the intake port of the engine intake duct, the intake port of the CVT intake duct, and the intake port of the fan intake duct are located at an interval in a vehicle width direction.

19. The off-road vehicle according to claim 1, further comprising:
a CVT exhaust duct connected to the continuously variable transmission to discharge air from the continuously variable transmission; and
a fan exhaust duct connected to the fan to discharge air from the fan,
wherein at least one of the CVT exhaust duct or the fan exhaust duct has, on a path thereof, a curved portion extending upward and then extending downward while extending from upstream to downstream.

20. The off-road vehicle according to claim 19, wherein
an upper end portion of the curved portion is located at a position higher than a seating surface of the seat.
